(19) United States
(12) Patent Application Publication
(10) Pub. No.: US 2001/0017483 A1
(43) Pub. Date: Aug. 30, 2001

(54) Device and process for the remote interrogation and/or remote control of a building function

(76) Inventor: Wolfgang Frohberg, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/788,561

(22) Filed: Feb. 21, 2001

(30) Foreign Application Priority Data
Feb. 26, 2000 (DE) 100 09 109.1

(51) Int. Cl. H02J 1/00; H02J 3/00; H04B 3/54; G01M 1/38; G05B 13/00; G05B 15/00; G05B 21/00; G05D 23/00

(52) U.S. Cl. 307/1; 700/275

(57) ABSTRACT

The invention relates to a device (1) and a process for the remote interrogation and/or remote control of a building function (4, 5, 6, 7) by a subscriber from a terminal (12, 13, 19, 23) via a telecommunications network (2). In order to improve the remote interrogation and/or remote control of the building functions (4,5, 6, 7) inasmuch as said interrogation and/or remote control can be performed from arbitrary terminals (11, 12, 13, 19, 23) via arbitrary telecommunications networks (2, 17, 18) and the input of interrogation- and/or control commands is simplified and the output of the result of a remote interrogation at the terminal (12, 13, 19, 23) is rendered clearer and more intelligible, it is proposed that the telecommunications network (2) is connected on the one hand to an intelligent network (14) and on the other hand to a control device (8) for the building function (4, 5, 6, 7). The intelligent network (14) manages the telecommunications network (2, 17, 18) currently used by the subscriber and the address under which the subscriber can currently be reached. In addition, the intelligent network (14) converts data transmitted between the terminal (11, 12, 13, 19, 23) and the control device (8) of the building function (4, 5, 6, 7) between the data format of the control device (8) and a data format of the terminal (11, 12, 13, 19, 23).

### TECHNICAL FIELD

The present invention relates to a device and a process for the remote interrogation and/or remote control of a building function by a subscriber from a terminal via a telecommunications network.

The invention is based on priority application DE 100 09 109.1, which is hereby incorporated by reference.

### BACKGROUND OF THE INVENTION

In recent years an increasing linking of building functions has been observable under the term “building management”. The building functions comprise the recording of information (e.g. the external temperature, the internal temperature in different rooms, the temperature of a boiler, the power consumption of individual devices or of the entire building, the location and number of the open windows, the location, number and heating level of the turned-on heaters, the current water consumption of a device or of the entire building). This information is normally recorded via suitable sensors. However the building functions also comprise the execution of specific actions (e.g. the switching off of the boiler at night, the activation/deactivation of selected heaters, the activation/deactivation of selected lights, the activation/deactivation of selected devices). Specific actions are normally performed via suitable actors. The building functions are called in time-dependent and/or event-dependent manner. The individual building functions influence one another and thus enable the building functions to be optimised, in particular in terms of running the building in as resource-saving as possible a manner (e.g. automatic activation of a heater, light or other functions upon entry of a room and automatic deactivation of the functions upon exit from the room). The building functions are coordinated by a central control device.

From the prior art it is known to perform a remote interrogation and/or remote control of the building functions from a terminal via a telecommunications network. This is conditional upon the control device for the building functions being connected to the telecommunications network like a conventional terminal. The telecommunications network has the form of a telephone network for example. The telephone network can be of digital construction (e.g. an integrated-services-digital-network (ISDN)) or analogue construction. For the remote interrogation and/or remote control a subscriber dials into the control device via the terminal. The subscriber inputs the required interrogation- or control commands into the terminal in a data format intelligible to the control device. The interrogation- or control commands are input for example in menu-driven manner by voice input or keyboard input in accordance with the dial-tone-multiple-frequency (DTMF) method. The control device executes the interrogation- or control commands and in the course of a remote interrogation interrogates for example a sensor state of a building function, which it receives and transmits to the terminal. The output of the result of the remote interrogation at the terminal takes place in accordance with the prior art either via voice output (e.g. on a telephone) or via text output (e.g. on the screen of a computer which has access to the telecommunications network). In the same way, in the course of a remote control of a building function the control device can cause a specific actor assigned to the building function to perform a desired action.

In the case of the remote interrogation and/or remote control of a building function known from the prior art, it is disadvantageous that the remote interrogation and/or remote control can only take place via a terminal connected to a telecommunications network. Additionally, the possibilities of inputting interrogation- and/or control commands and the possibilities of displaying the result of a remote interrogation on the terminal are very limited and not very convenient for the subscriber.

### SUMMARY OF THE INVENTION

Therefore the object of the present invention is to improve the remote interrogation and/or remote control of building functions inasmuch as they can be executed from arbitrary terminals via arbitrary telecommunications networks, and that the input of interrogation- and/or control commands is simplified and the output of the result of a remote interrogation at the terminal is rendered clearer and more intelligible.

To achieve this objective, commencing from the device for the remote interrogation and/or remote control of the type referred to in the introduction, the invention proposes that the telecommunications network is connected on the one hand to an intelligent network and on the other hand to a control device for the building function.

Advantageously, the intelligent network is connected via further telecommunications networks to further terminals for the remote interrogation and/or remote control of the building function.

The functions required for the remote interrogation and/or remote control are distributed between the terminal and the intelligent network. An intelligent network is superordinate to the telecommunications network. The intelligent network comprises a server (service-control-point SCP) and a so-called intelligent peripheral. On the basis of specific events at the location of the calling subscriber, the intelligent network is introduced into the connection establishment and the handling of the connection. As superordinate network, the intelligent network provides the conditions for accessing the control device from an arbitrary terminal via an arbitrary telecommunications network.

The functionality of the remote interrogation and/or remote control of a building function can be decisively extended by means of the device according to the invention. For example, it is conceivable for the interrogation- and/or control commands to be input via the terminal in a data format particularly convenient for the subscriber, and then, in the intelligent network, to be converted into a data format intelligible to the control device. Additionally, the result of a remote interrogation can be conditioned by the intelligent network in a form which is particularly clear and intelligible to the subscriber and output via the terminal to the subscriber.

In accordance with the invention, from a suitable terminal (personal computer (PC), personal-digital-assistant (PDA), mobile telephone with a wireless-application-protocol (WAP) facility etc.) it is now possible to access the intelligent network, for example via the internet, and to perform a remote interrogation and/or remote control of the building function. In the same way, the intelligent network can also be accessed from a suitable terminal (mobile telephone, PC or PDA with mobile telephony function etc.) via a mobile telephony network. Finally, as previously, the intelligent network can also be accessed from a suitable terminal (telephone, PC or PDA with telephone function) via the telecommunications network.

In accordance with an advantageous further development of the present invention, it is proposed that the intelligent network initiates the establishment of a communications connection between the terminal and the control device for the building function via the heterogeneous telecommunications network structure. The heterogeneous telecommunications network structure comprises at least the intelligent network and arbitrary telecommunications networks, e.g. a telephone network, the internet or an intranet. In accordance with this further development, from the terminal the subscriber dials the server of the intelligent network via a telecommunications network. Then the interrogation- and/or control commands are transmitted from the terminal to the server of the intelligent network. In the server or the intelligent peripheral of the intelligent network, the transmitted commands are processed and evaluated. If necessary the intelligent network then initiates the establishment of a communications connection via the telecommunications network to the control device and transmits the commands to the control device. The control device performs an action corresponding to the commands, i.e. determines a sensor signal or actuates an actor in an appropriate manner.

In accordance with another further preferred embodiment of the present invention, it is proposed that the intelligent network comprises means for managing the telecommunications network currently used by the subscriber and for managing the address under which the subscriber can currently be reached. The intelligent network thus follows the current position of the subscriber. The information as to where the subscriber can be reached is stored in the intelligent network in order to ensure that the subscriber can be reached as quickly as possible. It can be of great importance to notify the subscriber as rapidly as possible in the case of the transmission of the state of specific building functions, for example the alarm system.

In accordance with another advantageous further development of the present invention, the intelligent network comprises means whereby the data transmitted between the terminal and the control device of the building function can be converted between a data format of the control device and a data format of the terminal. In addition to a technically required interface function, the means for converting the data can also convert the transmitted data between a user-friendly data format for the terminal and a data format for the building function control device which is reduced to that which is essential. The user-friendly data format facilitates, for example, an input of interrogation- and/or control commands via a self-explanatory menu structure on the screen of a computer or a conditioning of the interrogation results of the building function and a graphic representation of the conditioned data on the screen of a computer.

In accordance with a preferred embodiment of the present invention it is proposed that the intelligent network comprises means for recording the communication between the terminal and the control device for the building function. The communication can be recorded for documentation purposes, checking purposes or following the occurrence of a fault for diagnosis purposes.

Advantageously, the intelligent network comprises means for identifying and/or authenticating the subscriber. In accordance with the prior art, the identification and authentication were previously performed by the control device for the building function. Due to the assignment of this function to the intelligent network, it is possible on the one hand to reduce the load on the control device and on the other hand to considerably improve and expand the identification- and authentication functions. The server and the intelligent peripheral of the intelligent network have available considerably more resources in order to a perform a particularly secure and reliable identification and/or authentication of the subscriber. Only when the subscriber has been successfully identified and authenticated does the intelligent network then establish the communications connection between the terminal and the control device for the building function.

The telecommunications network advantageously has the form of a digital telecommunications network with digital terminals, in particular an integrated-services-digital-network (ISDN).

The telecommunications network or further telecommunications network preferably has the form of the internet, an intranet, a mobile telephony network, an integrated-services-digital-network (ISDN), an analogue telephony network or a radio paging service network. Via a radio paging service network (e.g. euro-signal of the CEPT (Confederation of European Postal- and Telephone Administrations), Ermes (European Radio Message System) or Scall) data can be transmitted without acknowledgement in one direction to suitable terminals (e.g. euro-beepers, pagers). Via this variety of telecommunications networks, in accordance with the present invention corresponding terminals can access the control device for the building function via the intelligent network.

To achieve the objective of the present invention on the basis of the process for the remote interrogation and/or remote control of the type referred to in the introduction, it is further proposed that a communications connection is established between the terminal and a control device for the building function via an intelligent network, data for the remote interrogation and/or remote control of the building function being transmitted via the communications connection.

The present invention also relates to a particularly advantageous use of an intelligent network for the remote interrogation and/or remote control of a building function. The remote interrogation and/or remote control is performed by a subscriber from a terminal via a telecommunications network. Here the terminal forms part of an arbitrary telecommunications network. The intelligent network initiates the establishment of a communications connection between the terminal and a control device for the building function. Data for the remote interrogation and/or remote control of the building function are transmitted via the communications connection.

### BRIEF DESCRIPTION OF THE DRAWINGS

A preferred exemplary embodiment of the present invention will be explained in detail in the following making reference to the drawing in which:

FIGURE 1 illustrates a device according to the invention in a preferred embodiment.

### BEST MODE FOR CARRYING OUT THE INVENTION

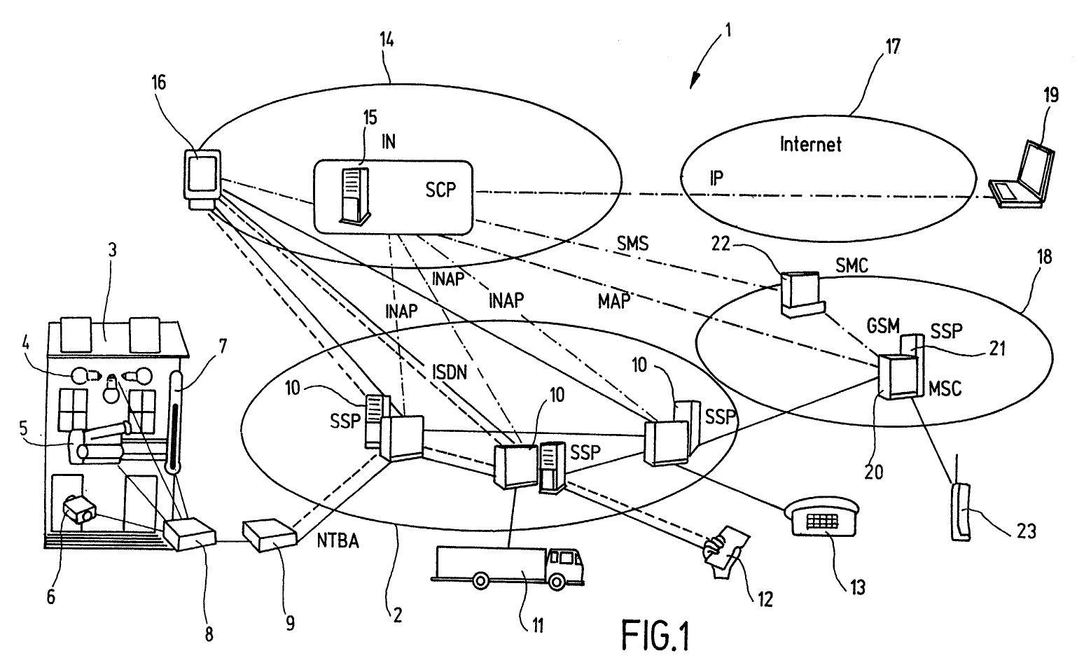

In FIG. 1, a device according to the invention for the remote interrogation and/or remote control of a building function has been provided with the overall reference 1. The remote interrogation and/or remote control is performed by a subscriber from a terminal via a telecommunications network 2. The telecommunications network 2 has the form of a digital telecommunications network with preferably digital terminals, in particular an integrated-services-digital-network (ISDN). The building in which specific building functions can be accessed via remote interrogation and/or remote control has been referenced 3. By way of example, a light 4, a video monitoring unit 5, an alarm system 6 and an external temperature measuring device 7 have been represented as possible building functions in FIG. 1. The individual building functions 4, 5, 6, 7 are coordinated by a control device 8. This type of coordination of different building functions by a control device is also known under the term “building management”. The control device 8 is connected like a conventional terminal to the telecommunications network 2 via a so-called network-termination-basic-access (NTBA) 9. The communication in the building 3 between the building functions 4, 5, 6, 7 and the NTBA 9 via the control device 8 takes place via an application-specific standard (thin, continuous lines in FIG. 1) which is dependent upon the standard used for the building management.

The telecommunications network 2 comprises for example three exchanges referred to a service-switching-points (SSP) 10, via which different terminals are connected to the telecommunications network 2. An emergency call control centre 11, a so-called personal-digital-assistant (PDA) 12 and a telephone (analogue or digital) 13 have been represented by way of example in FIG. 1 as terminals connected to the telecommunications network 2. The thick continuous lines from and to the telecommunications network 2 represent the B-channels of the ISDN and the broken lines represent the D-channel of the ISDN. The dash-dotted lines represent other communications connections (e.g. signalling).

The telecommunications network 2 is connected to a so-called intelligent network (IN) 14. An intelligent network is superordinate to an analogue or digital telecommunications network. The intelligent network 14 comprises a server 15 referred to as service-control-point (SCP) and a so-called intelligent peripheral 15 which undertakes subsidiary functions of the intelligent network 14.

The control device 8 initiates a call, whereupon the SSP 10, connected to the intelligent network 14, of the telecommunications network 2 assigns the establishment of the communications connection to the server 15. The server 15 processes the call such that upon the occurrence of specific events, specific actions are performed. If the server 15 determines that the call must be forwarded, it communicates this fact together with the converted subscriber number to the SSP 10, from where the further establishment of the call then takes place. The communication between the SSP 10 of the telecommunications network 2 and the server 15 of the intelligent network 14 takes place in accordance with the intelligent-net-application-protocol (INAP).

The intelligent network 14 is connected to further telecommunications networks, of which the internet 17 and a mobile telephony network 18 have been represented by way of example in FIG. 1. Via the internet 17, a communications connection can be established from a suitable terminal 19 in the form of a laptop 19 to the server 15 of the intelligent network 14. Via this communications connection the transmission of the data to be transmitted takes place in accordance with the so-called internet-protocol (IP). The mobile telephony network 18 operates in accordance with the global-systems-for-mobile-communications (GSM) standard.

The mobile telephony network 18 comprises a server 20 referred to as mobile-switching-centre (MSC), a service-switching-point (SSP) 21 and a short-message centre (SMC) 22. From a suitable terminal 23 in the form of a mobile telephone, a communications connection to the server 15 of the intelligent network 14 can be established via the mobile telephony network 18. Between the server 15 and the server 21 the data transmission to the terminal 23 takes place in accordance with the mobile-application-protocol (MAP), the signalling protocol of GSM networks, or the short-message-service (SMS).

The terminals 11, 12, 13, 19, 23 of the different telecommunications networks 2, 17, 18 contain applications which emit data to the building functions 4, 5, 6, 7 and can display data from the building functions 4, 5, 6, 7 of the building 3. In the case of the telephone 13, the data output takes place for example by voice and the data input takes place by voice or via the multi-frequency-dialling method (dial-tone-multiple-frequency, DTMF). On the other hand in the case of a PDA 12 or laptop 19, the data output can take place in graphic form on a screen and the data input can take place via a user-friendly menu structure displayed on the screen using a keyboard, mouse or other input means.

The different building functions 4, 5, 6, 7 of the building 3 and the terminals 11, 12, 13, 19, 23 are physically linked to one another via conventional telecommunications networks—the internet 17 or the mobile telephony network 18—the intelligent network 14 and the ISDN 2. The structures and mechanisms of the intelligent network 14 are used to coordinate the communication and to implement communications-relevant parts of the applications of the building management. The tasks of the intelligent network 14 comprise in particular:

The establishment of a communications connection between a terminal 11, 12 13, 19, 23 and the control device 8 for the building functions 4, 5, 6, 7 via the heterogeneous telecommunications network structure.

Recording of the communication between a terminal 11, 12, 13, 19, 23 and the control device 8 for the building function 4, 5, 6, 7.

Management of the telecommunications network 2, 17, 18 currently used by the subscriber and of the address (e.g. IP address or telephone number) under which the subscriber can currently be reached.

Identification and/or authentication of the subscriber.

Conversion of the data transmitted between a terminal 11, 12, 13, 19, 23 and the control device 8 of the building functions 4, 5, 6, 7 between a data format of the control device 8 and a data format of the terminal 11, 12, 13, 19, 23.

If a subscriber, for example with a mobile telephone terminal 23, is located for example in the region of the mobile telephony network 18 and uses the SMS service of the mobile telephony network 18 to communicate with the building functions 4, 5, 6, 7 of the building 3, in order to remotely interrogate building functions 4, 5, 6, 7 he drafts a short message (SMS) in a given data format. The short message is forwarded via the short message centre (SMC) 22 to the server 15 of the intelligent network 14. In the server 15 or the intelligent peripheral 16, a command sequence is generated which can be transmitted via ISDN and can be evaluated for the control device 8 of the building function 4, 5, 6, 7. From the intelligent peripheral 16, a communications connection is then established to the NTBA 9 of the building 3 and the command sequence is transmitted to the control device 8. Advantageously, this takes place via a B-channel of the ISDN. The control device 8 receives and processes the command sequence, and causes the building functions 4, 5, 6, 7 to perform the corresponding actions. If necessary, the control device 8 returns the result of an interrogation of a building function 4, 5, 6, 7 via the telecommunications network 2 to the intelligent network 14, where the interrogation result is conditioned, transmitted to the mobile telephone terminal 23 of the subscriber, and output therefrom in a manner which is clear and convenient for the subscriber. This can comprise, for example, a graphic presentation of the interrogation result on a screen of the mobile telephone terminal 23 (as SMS short message).

If for example the building monitoring system 5 is activated in the building 3 and an intruder is detected, the control device 8 dispatches a corresponding alarm call to an emergency call control centre 11. For this purpose the control device 8 initiates a call. The SSP 10 recognises that the call has been initiated by the control device 8 and assigns the connection establishment to the server 15 of the intelligent network 14. The control device 8 transmits data, referring to an intruder in the building 3, to the SSP 10 which forwards the data relevant to the intelligent network to the server 15. In dependence upon the data, the server 15 initiates the performance of specific actions, in the present example the establishment of a communications connection to the emergency call control centre 11 via the SSP 10.

Additionally, the server 15 conditions the data in such manner that the emergency call control centre 11 is presented with all the required information as comprehensively, conveniently and clearly as possible. Thus for example, in addition to the reference to an intruder in the building 3, it is also possible to add the state of movement sensors distributed in the building 3, or the current location of the owner of the building 3 (in this case referred to as the subscriber). It would also be conceivable to transmit recorded images of the intruder from the video monitoring unit 5 in the building 3 to the emergency call control centre 11. A corresponding, conditioned alarm message is transmitted from the intelligent network 14 to the emergency call control centre 11 via the telecommunications network 2.

Additionally, the intelligent network 14 can cause the subscriber to be informed about the intruder. For this purpose it is necessary to determine the telecommunications network 2, 17, 18 in which the subscriber is located and the address (IP- address, telephone number) under which he can be reached. It may be necessary to convert the alarm message into a suitable data format before it can be forwarded to the terminal 12, 13, 19, 23 of the subscriber.

What is claimed is:

1. A device for the remote interrogation and/or remote control of a building function by a subscriber from a terminal via a telecommunications network, in which the telecommunications network is connected on the one hand to an intelligent network and on the other hand to a control device for the building function.

2. A device according to claim 1, characterised in that the intelligent network is connected via further telecommunications networks to further terminals for the remote interrogation and/or remote control of the building function.

3. A device according to claim 1, characterised in that the intelligent network initiates the establishment of a communications connection between the terminal and the control device for the building function via the heterogeneous telecommunications network structure.

4. A device according to claim 1, characterised in that the intelligent network comprises means for managing the telecommunications network currently used by the subscriber and for managing the address under which the subscriber can currently be reached.

5. A device according to claim 1, characterised in that the intelligent network comprises means for converting the data transmitted between the terminal and the control device of the building function between a data format of the control device and a data format of the terminal.

6. A device according to claim 1, characterised in that the intelligent network comprises means for recording the communication between the terminal and the control device for the building function.

7. A device according to claim 1, characterised in that the intelligent network comprises means for identifying and/or authenticating the subscriber.

8. A device according to claim 1, characterised in that the telecommunications network has the form of a digital telephony network with digital terminals, in particular an integrated-services-digital-network (ISDN).

9. A device according to claim 1, characterised in that the telecommunications network or the further telecommunications network has the form of the internet, an intranet, a mobile telephony network, an integrated-services-digital-network (ISDN), an analogue telephony network or a radio paging service network.

10. A process for the remote interrogation and/or remote control of a building function by a subscriber from a terminal via a telecommunications network, in particular by means of a device according to one of the preceding claims, characterised in that the establishment of a communications connection between the terminal and a control device for the building function is initiated by an intelligent network superordinate to the telecommunications network and data for the remote interrogation and/or remote control of the building function being transmitted via the communications connection.

11. A process according to claim 10, characterised in that the establishment of a communications connection between a further terminal of a further telecommunications network, which is connected to the intelligent network, and the control device is initiated by the intelligent network.

12. A process according to claim 10, characterised in that the telecommunications network currently used by the subscriber and the address under which the subscriber can currently be reached are managed by the intelligent network.

13. A process according to claims 10, characterised in that data transmitted between the terminal and the control device of the building function are converted by the intelligent network between a data format of the control device and a data format of the terminal.

14. The use of an intelligent network for the remote interrogation and/or remote control of a building function by a subscriber from a terminal via at least one telecommunications network, wherein the telecommunications networks are connected to the intelligent network, at least one of the telecommunications networks is connected to a control device for the building function, and the intelligent network initiates the establishment of a communications connection between the terminal and the control device via which data for the remote interrogation and/or remote control of the building function are transmitted.
